(19) United States
(12) Patent Application Publication
(10) Pub. No.: US 2026/0044445 A1
(43) Pub. Date: Feb. 12, 2026

(54) HOSTS AND OPERATION METHODS THEREOF, SYSTEMS AND COMPUTER READABLE MEMORY MEDIUMS

(71) Applicant: YANGTZE MEMORY TECHNOLOGIES CO., LTD., Wuhan (CN)

(72) Inventors: Yuetan WANG, Wuhan (CN); Yue MA, Wuhan (CN); Kaiyao CAO, Wuhan (CN)

(21) Appl. No.: 19/011,369

(22) Filed: Jan. 6, 2025

(30) Foreign Application Priority Data
Aug. 6, 2024 (CN) 202411073909X

(51) Int. Cl. G06F 12/02

(52) U.S. Cl. CPC G06F 12/0246; G06F 2212/7202; G06F 2212/7204

(57) ABSTRACT

Examples of the present disclosure provide hosts and operation methods thereof, systems and computer readable memory mediums. An example host includes: a buffer configured to store a target zone data structure; and a host processor configured to: send a first command, wherein the first command is to obtain information of each zone of a zone namespace (ZNS); and maintain the target zone data structure based on the information of each zone, wherein the target zone data structure includes information of a target zone, and the target zone is a zone where a memory mode is a first memory mode.

### CROSS-REFERENCE TO RELATED APPLICATIONS

The present application claims the benefit of priority to Chinese Patent Application No. 202411073909X, which was filed Aug. 6, 2024, and is hereby incorporated herein by reference in its entirety.

### TECHNICAL FIELD

Examples of the present disclosure relate to the field of memory technologies, and in particular, to a host and an operation method thereof, system and a computer readable memory medium.

### BACKGROUND

Memory device and system thereof are memory devices for storing information in modern information technology. With the continuous increase of the requirements of memory devices, there is room for improvement in memory device and system thereof.

### SUMMARY

Examples of the present disclosure provide a host and an operation method thereof, system and a computer readable memory medium.

According to a first aspect, an example of the present disclosure provides a host, including: a buffer configured to store a target zone data structure; and a host processor configured to: send a first command, wherein the first command is to obtain information of each zone of a zone namespace (ZNS); and maintain the target zone data structure based on the information of each zone, wherein the target zone data structure includes information of a target zone, and the target zone is a zone where a memory mode is a first memory mode.

In some examples, the host processor is configured to: obtain report zone parameter data through the first command, wherein the report zone parameter data includes memory mode information indicating a memory mode of the zone; and obtain the information of the target zone according to the report zone parameter data.

In some examples, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, wherein M and N are integers greater than or equal to 1, and M is greater than N.

In some examples, N is equal to 1, and M is an integer greater than 1.

In some examples, the host processor is configured to: send a second command, wherein the second command is to instruct to configure at least one zone as the target zone.

In some examples, the information of the target zone includes an identifier of the target zone, a condition of the target zone, and an identifier of the currently used target zone.

In some examples, the target zone data structure includes a number of target zones, a list of target zone linked lists, and the identifier of the currently used target zone, wherein the list of target zone linked lists includes at least one target zone linked list, and the target zone linked list includes an identifier of the target zone, the condition of the target zone, and a linked list pointer of a next target zone linked list.

In some examples, the host is further configured with a file system, and the host processor is configured to: send the second command in a preset scenario, wherein the preset scenario includes at least one of the following: an initialization period of the file system, in a case where the information of the target zone is not obtained through the first command, and in a case where the condition of the currently used target zone in the target zone data structure is a full condition.

In some examples, the host processor is configured to: determine, by the file system, a cold-hot attribute of the write data, and allocate the zone to the write data according to the cold-hot attribute of the write data; allocate a zone where the memory mode is the first memory mode to the write data when determining, by the file system, that the write data is hot data; and allocate a zone where the memory mode is the second memory mode to the write data when determining, by the file system, that the write data is non-hot data.

In some examples, the host processor is configured to: determine, by the file system, a cold-hot attribute of the write data, generate a corresponding zone write request according to the cold-hot attribute of the write data, and send the write data and the zone write request; the zone write request is to indicate to write the write data into a zone where the memory mode is the first memory mode when determining, by the file system, that the write data is hot data, and the zone write request is to indicate to write the write data into a zone where the memory mode is the second memory mode when determining, by the file system, that the write data is non-hot data.

In some examples, the host processor is configured to: determine to obtain a remaining space of the memory system when the condition of the currently used target zone in the target zone data structure is a full condition; and send the second command to the memory system according to a maximum continuous space in the remaining space satisfying a preset condition.

In some examples, the first command includes a report zone command, and the second command includes a reset write pointer command.

In some examples, the file system includes a flash friendly file system (F2FS).

According to a second aspect, an example of the present disclosure provides a system, including a host and a memory system coupled to the host; the memory system includes a memory device and a memory controller coupled to the memory device, the memory controller is configured to control the memory device to partition and store by zones, wherein a memory space of a single zone is configured to support only sequential writes; the host includes a host processor, a buffer, and a second interface for coupling to the memory controller, wherein the buffer is configured to store a target zone data structure, and the host processor is configured to: send a first command to the memory controller through the second interface; the first command is to obtain information of each zone of a ZNS; the memory controller is configured with a first interface for coupling to the host, and the memory controller is configured to: receive the first command through the first interface; send report zone parameter data to the host through the first interface according to the first command; the report zone parameter data includes memory mode information indicating a memory mode of the zone; and the host processor is further configured to: maintain the target zone data structure based on the information of each zone, wherein the target zone data structure includes information of a target zone, and the target zone is a zone where the memory mode is a first memory mode.

In some examples, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, wherein M and N are integers greater than or equal to 1, and M is greater than N.

In some examples, N is equal to 1, and M is an integer greater than 1.

In some examples, the host processor is configured to: send a second command to the memory controller through the second interface; and the memory controller is configured to: receive the second command through the first interface; and configure at least one of a plurality of zones as the target zone according to the second command.

In some examples, the information of the target zone includes an identifier of the target zone, a condition of the target zone, and an identifier of the currently used target zone.

In some examples, the target zone data structure includes a number of target zones, a list of target zone linked lists, and the identifier of the currently used target zone, wherein the list of target zone linked lists includes at least one target zone linked list, and the target zone linked list includes an identifier of the target zone, the condition of the target zone, and a linked list pointer of a next target zone linked list.

In some examples, the host is further configured with a file system, and the host processor is configured to: send the second command to the memory system in a preset scenario, wherein the preset scenario includes at least one of the following: an initialization period of the file system, in a case where the information of the target zone is not obtained through the first command, and in a case where the condition of the currently used target zone in the target zone data structure is a full condition.

In some examples, the host processor is configured to: determine, by the file system, a cold-hot attribute of the write data, and allocate the zone to the write data according to the cold-hot attribute of the write data; allocate a zone where the memory mode is the first memory mode to the write data when determining, by the file system, that the write data is hot data; and allocate a zone where the memory mode is the second memory mode to the write data when determining, by the file system, that the write data is non-hot data.

In some examples, the host processor is configured to: determine, by the file system, a cold-hot attribute of the write data, generate a corresponding zone write request according to the cold-hot attribute of the write data, and send the write data and the zone write request to the memory controller through the second interface; the zone write request is to indicate to write the write data into a zone where the memory mode is the first memory mode when determining, by the file system, that the write data is hot data, and the zone write request is to indicate to write the write data into a zone where the memory mode is the second memory mode when determining, by the file system, that the write data is non-hot data; and the memory system is configured to: receive the write data and the zone write request through the first interface; and write the write data into the memory space of the corresponding zone according to the zone write request.

In some examples, the host processor is configured to: determine to obtain a remaining space of the memory device when the condition of the currently used target zone in the target zone data structure is a full condition; and send the second command to the memory system through the second interface according to a maximum continuous space in the remaining space satisfying a preset condition; and the memory system is configured to: receive the second command through the first interface; and configure at least one of the plurality of zones as the target zone according to the second command.

In some examples, the first command includes a report zone command, and the second command includes a reset write pointer command.

In some examples, the file system includes a flash friendly file system.

According to a third aspect, an example of the present disclosure provides an operation method of a host, including: establishing a target zone data structure; sending a first command, wherein the first command is to obtain information of each zone of a ZNS; and maintaining the target zone data structure based on the information of each zone, wherein the target zone data structure includes information of a target zone, and the target zone is a zone where a memory mode is a first memory mode.

In some examples, the method further includes: obtaining report zone parameter data through the first command, wherein the report zone parameter data includes memory mode information indicating a memory mode of the zone; and obtaining the information of the target zone according to the report zone parameter data.

In some examples, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, wherein M and N are integers greater than or equal to 1, and M is greater than N.

In some examples, N is equal to 1, and M is an integer greater than 1.

In some examples, the method further includes: sending a second command, wherein the second command is to instruct to configure at least one zone as the target zone.

In some examples, the information of the target zone includes an identifier of the target zone, a condition of the target zone, and an identifier of the currently used target zone.

In some examples, the target zone data structure includes a number of target zones, a list of target zone linked lists, and the identifier of the currently used target zone, wherein the list of target zone linked lists includes at least one target zone linked list, and the target zone linked list includes an identifier of the target zone, the condition of the target zone, and a linked list pointer of a next target zone linked list.

In some examples, the establishing the target zone data structure includes: establishing the target zone data structure by a configured file system; the sending the second command includes: sending the second command in a preset scenario, wherein the preset scenario includes at least one of the following: an initialization period of the file system, in a case where the information of the target zone is not obtained through the first command, and in a case where the condition of the currently used target zone in the target zone data structure is a full condition.

In some examples, the method further includes: determining, by the file system, a cold-hot attribute of the write data, and allocate the zone to the write data according to the cold-hot attribute of the write data; allocating a zone where the memory mode is the first memory mode to the write data when determining, by the file system, that the write data is hot data; and allocating a zone where the memory mode is the second memory mode to the write data when determining that the write data is non-hot data.

In some examples, the method further includes: determining, by the file system, a cold-hot attribute of the write data, generating a corresponding zone write request according to the cold-hot attribute of the write data, and sending the write data and the zone write request; the zone write request is to indicate to write the write data into a zone where the memory mode is the first memory mode when determining, by the file system, that the write data is hot data, and the zone write request is used to indicate to write the write data into a zone where the memory mode is the second memory mode when determining, by the file system, that the write data is non-hot data.

In some examples, the sending the second command when the condition of the currently used target zone in the target zone data structure is a full condition includes: determining to obtain a remaining space of a target device when the condition of the currently used target zone in the target zone data structure is a full condition; and sending the second command according to a maximum continuous space in the remaining space satisfying a preset condition.

In some examples, the first command includes a report zone command, and the second command includes a reset write pointer command.

In some examples, the file system includes a flash friendly file system.

According to a fourth aspect, an example of the present disclosure provides a computer-readable memory medium, wherein the computer-readable memory medium includes computer programs that are executed to perform the method according to any one of the foregoing examples.

### BRIEF DESCRIPTION OF THE DRAWINGS

FIG. 1A is a first block diagram of a host provided in examples of the present disclosure.

FIG. 1B is a second block diagram of a host provided in examples of the present disclosure.

FIG. 2 is a schematic structural diagram of a report zone command provided in an example of the present disclosure.

FIG. 3A is a schematic structural diagram of report zone parameter data provided in an example of the present disclosure.

FIG. 3B is a schematic structural diagram of a zone descriptor in report zone parameter data provided in an example of the present disclosure.

FIG. 4 is a target zone data structure provided in an example of the present disclosure.

FIG. 5 is a flowchart of an operation method of a host provided in an example of the present disclosure.

FIG. 6 is a flowchart of another operation method of a host provided in an example of the present disclosure.

FIG. 7 is a block diagram of an example system with a host and a memory system according to some aspects of the present disclosure.

FIG. 8 is a flowchart of an operation method of a host provided in examples of the present disclosure.

### DETAILED DESCRIPTION

The technical solutions in the implementations of the present disclosure will be described below in combination with the examples of the present disclosure and the accompanying drawings, it is obvious that the described examples are only a part of the implementations of the present disclosure, not all implementations. All the other implementations obtained by those of ordinary skill in the art without creative efforts shall fall within the scope of the present disclosure.

In the following description, numerous details are given in order to provide a more thorough understanding of the present disclosure. However, it will be apparent to one skilled in the art that the present disclosure may be practiced without one or more of these details. In other examples, in order to avoid confusion with the present disclosure, some technical features known in the art are not described; for example, not all features of the actual example are described here, and well-known functions and structures are not described in detail.

In the drawings, the dimensions of layers, zones, elements, and their relative sizes may be exaggerated for clarity. Like reference numbers refer to like elements throughout.

It should be appreciated that when an element or layer is referred to as being “on,” “adjacent to,” “connected to,” or “coupled to” other elements or layers, it may be directly on, adjacent to, connected to, or coupled to other elements or layers, or there may be intervening elements or layers. Conversely, when an element is referred to as being “directly on,” “directly adjacent to,” “directly connected to,” or “directly coupled to” other elements or layers, there is no intervening element or layer. It should be appreciated that although the terms first, second, third, etc., may be used to describe various elements, components, regions, layers, and/or portions, these elements, components, regions, layers, and/or portions should not be limited by these terms. These terms are used merely to distinguish one element, component, zone, layer, or portion from another element, component, zone, layer, or portion. Thus, the first element, component, zone, layer, or portion discussed below may be represented as a second element, component, zone, layer, or portion without departing from the teachings of the present disclosure. When the second element, component, zone, layer, or portion is discussed, it is not intended that the present disclosure necessarily include a first element, component, zone, layer, or portion.

Spatial relation terms such as “beneath,” “below,” “lower,” “under”, “above,” “upper,” etc., may be used herein for ease of description to describe the relationship between one element or feature and other elements or features shown in the figures. It should be appreciated that in addition to the orientations shown in the figures, the spatial relation term intent to also include different orientations of the devices in use and operation. For example, if the devices in the figures are flipped, then described as “below” or “under” or “beneath” other elements or features will be oriented “on” other elements or features. Thus, the example terms “below” and “under” may include both upper and lower orientations. The devices may be additionally oriented (rotated 90 degrees or other orientations) and the spatial description terminology used herein is interpreted accordingly.

A term used herein is for the purpose of describing a particular example only and is not to be considered as limitation of the present disclosure. As used herein, the singular forms “a”, “an” and “said/the” are intended to include the plural forms as well, unless the context clearly dictates otherwise. It should also be understood that the terms “consists of” and/or “comprising”, when used in this description, identify the presence of the said features, integers, steps, operations, elements and/or parts, but do not exclude the presence and addition of one or more other features, integers, steps, operations, elements, parts and/or groups. As used herein, the term “and/or” includes any and all combinations of the associated listed items.

For a thorough understanding of the present disclosure, detailed steps and detailed structures will be presented in the following description in order to explain the technical solutions of the present disclosure. Preferred examples of the present disclosure are described in detail below, however, other implementations may be provided in addition to these detailed descriptions.

With the rapid development of computer technologies and Internet technologies, the demand for data memory increases dramatically, and a zone namespace (ZNS) is proposed. The ZNS facilitates to place the write data of the user in certain zones of the memory device according to the usage frequency of the write data, thereby reducing the rewriting and rearrangement of the stored data, so that the overall performance and life of the hard disk are improved. The ZNS may allow for flexible and dynamic SSD configurations to enable dynamic capacity management and mixed-mode NAND operations.

Examples of the present disclosure provide a host, including: a buffer configured to store a target zone data structure, and a host processor configured to: send a first command, where the first command is used to obtain information of each zone of a zone namespace (ZNS); and maintain the target zone data structure based on the information of each zone, where the target zone data structure includes information of a target zone, and the target zone is a zone where a memory mode is a first memory mode.

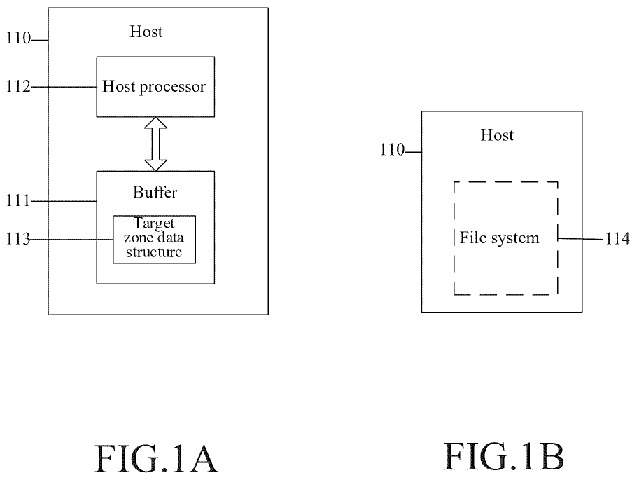

FIG. 1A is a first block diagram of a host provided in examples of the present disclosure. As shown in FIG. 1A, the host 110 includes a buffer 111 and a host processor 112. The buffer 111 may be a random access memory (RAM), the buffer 111 may be configured to store instructions and data, and may be directly and randomly accessed by the host processor 112. For example, the buffer 111 may be configured to store the target zone data structure 113. The host processor 112 is the operation and control core of the host 110, and is the final execution unit for information processing and program running.

In the examples of the present disclosure, the host 110 may be a processor (for example, a central processing unit (CPU)) or a system on chip (SoC) (for example, an application processor (AP)) of the electronic device.

In the examples of the present disclosure, the host may be coupled to the memory system and perform data communication with the memory system, where the memory system comprises a memory device and a memory controller, and the memory controller is configured to control the memory device to partition and store by zones.

In some implementations, the zone is in a zone namespace (ZNS). The ZNS divides the logical address space of a namespace into a plurality of zones. A zone is a fixed-size sub-interval in the ZNS, and each zone has a logical block address (LBA) interval. Typically, in ZNS, an external device (e.g., host 110) provides a definition of a logical block address to the memory system. For example, the host 110 may indicate a portion of LBA interval corresponding to the first zone, a portion of LBA interval corresponding to the second zone, and so on. The memory system then maps each zone in the ZNS to a physical block in the memory device. For example, the memory system may map an LBA corresponding to a first zone to a first physical block, map an LBA corresponding to a second zone to a second physical block, and so on.

In some implementations, a memory capacity of a single zone is less than a memory capacity corresponding to a physical block of the memory device. Herein, the memory capacity may refer to how much memory space that the memory device can provide.

In some implementations, the zone namespace (ZNS) may have a preset or adjustable memory capacity. A memory system that supports a zone namespace (ZNS) may include one or more zone namespace (ZNS) memories, a memory system that supports a zone namespace (ZNS) may establish multiple zones, such that the memory controller may control the memory device to partition and store by zones. For example, data transferred by the host 110 may be stored in a zone, and the memory system may allocate at least one memory block to each zone. The memory system may sequentially store the data transferred by the host 110 in a zone specified by a corresponding LBA.

In the memory system that supports the zone namespace ZNS, only sequential writes but not random writes are supported within the zone in the zone namespace ZNS, while zones in the zone namespace ZNS may support random reads and sequential reads.

In some implementations, the memory system may also include one or more conventional namespaces (CNS) in addition to the zone namespace ZNS.

In the examples of the present disclosure, the host may send a first command to the memory system through the host processor, where the first command is to obtain information of each zone of the ZNS of the memory device in the memory system. In some examples, the first command may be a command in zoned block commands (ZBC). In an example, the first command is a report zone command. Here, the first command is a command conforming to a Zoned Universal Flash Memory (zoned UFS) protocol format.

In some examples, the memory system may generate report zone parameter data including the memory mode information according to the first command, and send the report zone parameter data to the host processor.

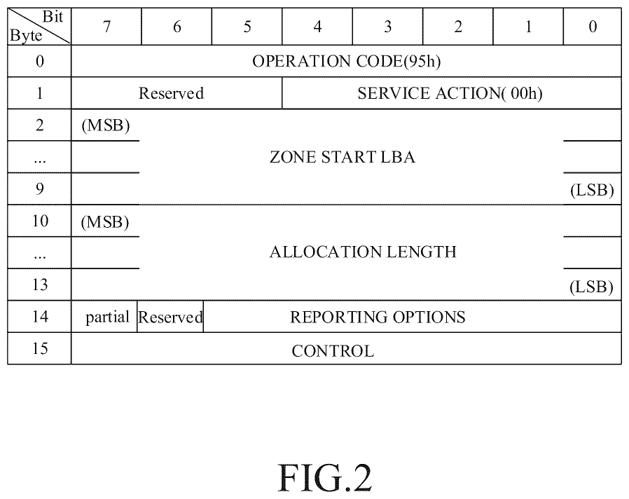

FIG. 2 is a schematic structural diagram of a report zone command provided in an example of the present disclosure. As shown in FIG. 2, the report zone command may include an operation code field, a service action field, a zone start logic block address (LBA) field, an allocation length field, a partial bit, a reporting options field, a control byte, and a reserved field, etc. The various fields and information included in the report zone command may be understood with reference to the zone block command ZBC specification.

In the examples of the present disclosure, the memory controller may generate the report zone parameter data including the memory mode information based on the first command.

In the examples of the present disclosure, the host processor 112 is configured to: obtain report zone parameter data through a first command, where the report zone parameter data includes memory mode information indicating a memory mode of the zone; and obtain the information of the target zone according to the report zone parameter data.

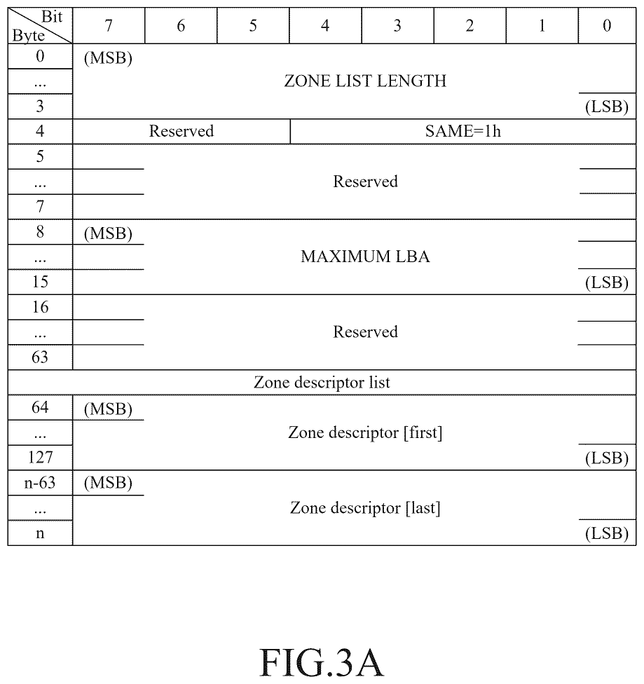

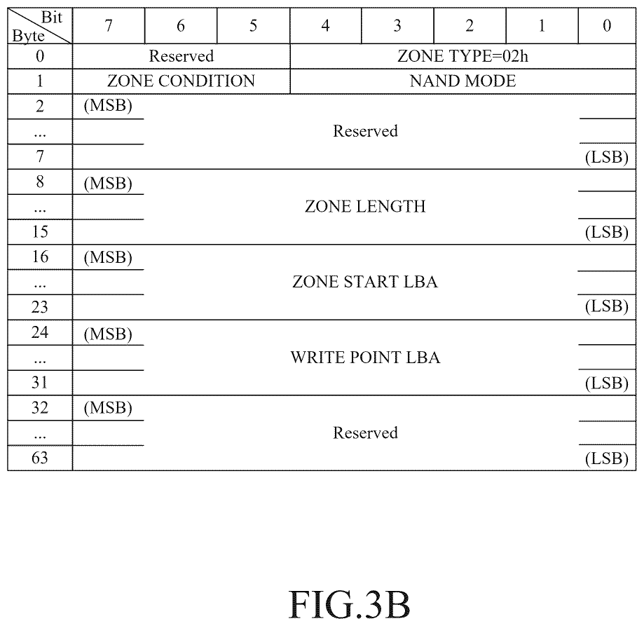

FIG. 3A is a schematic structural diagram of report zone parameter data provided in an example of the present disclosure. As shown in FIG. 3A, the report zone parameter data may include a zone descriptor list, a common descriptor, and a reserved field, etc.; the zone descriptor list includes at least one zone descriptor, where the zone descriptor is to indicate a self-attribute of the corresponding zone, and the common descriptor is to indicate a common attribute of the plurality of zones. The common descriptor includes a zone list length field, a same field, and a maximum logical block address (LBA) field and a reserved field, etc.

In some implementations, memory mode (e.g., NAND mode) information is located in the zone descriptor in the report zone parameter data.

FIG. 3B is a schematic structural diagram of a zone descriptor in report zone parameter data provided in an example of the present disclosure. FIG. 3B shows a zone descriptor including memory mode information. As shown in FIG. 3B, the zone descriptor may further include a zone type field, a zone condition field, a zone length field, a zone start LBA field, a write pointer LBA field, and a reserved field, etc. The various fields and information included in the report zone parameter data and the various fields and information included in the zone descriptor may be understood with reference to the ZBC specification. For example, the zone type field may define the access type of the zone namespace, and the zone type field is 02h to indicate that the zone namespace needs to be written in sequence. For another example, the same field may define a zone type and a zone length in each zone descriptor in a list of zone descriptors, and the same field is 1h to indicate that a zone type and a zone length in each zone descriptor in the list of zone descriptors are same.

In some implementations, the zone condition field may be employed to indicate a zone condition of the zone, the zone condition including an empty condition, an open condition, a full condition. In the empty condition, there is no valid data in the zone, and the write pointer of the zone is set to the start LBA in the zone, and after receiving the partition open command sent by the host, the zone where the zone condition is empty condition will be switched to the open condition. In the open condition, there may or may not be valid data in the zone, and the write pointer of the zone points to a certain location between the start LBA in the zone and the end of the last LBA, and the memory space corresponding to the zone may receive the write data for data writing through the write command. Additionally, the host may reset the zone to clear or erase valid data stored in the zone such that the zone is reset to an empty condition. Once the memory space corresponding to the zone is a full condition, the zone is switched to the full condition. In the full condition, the memory space corresponding to the zone is a full condition and cannot be opened again to receive the write data.

In some implementations, the memory mode information may be included in a reserved field not used in a zone descriptor in a report zone parameter based on an existing ZBC specification. As shown in FIG. 3B, the memory mode information occupies a first bit to a fourth bit of a second byte in the zone descriptor. In an example, when the memory mode information is 01h, it indicates that the memory mode of the zone is the first memory mode; and when the memory mode information is 02h, it indicates that the memory mode of the zone is the second memory mode.

In some other implementations, the memory mode information may also indicate the number of bits of the data stored in the memory cell included in the memory space of the zone. In an example, when the memory mode information is 01h, it indicates that the number of bits of the data stored in the memory cell included in the memory space of the zone is N; when the memory mode information is 02h, it indicates that the number of bits of the data stored in the memory cell included in the memory space of the zone is M, where N is 1, and M is 3.

In the examples of the present disclosure, after obtaining the information of each zone of the ZNS, the host processor may maintain a target zone data structure stored in the buffer based on the information of each zone. For example, the host processor may maintain a target zone data structure stored in the buffer based on the information of the target zone in each zone. Alternatively, the host processor may maintain the target zone data structure stored in the buffer based on the information of the target zone and the information of the non-target zone in each zone. Here, the non-target zone is a zone where the memory mode is the second memory mode.

In the examples of the present disclosure, the target zone data structure includes information of the target zone, and the target zone is a zone where the memory mode is the first memory mode. In an example, the host memory device may maintain the target zone data structure stored in the buffer based on the information of each zone to update the information of the zone where the memory mode is the first memory mode in the target zone data structure.

In the examples of the present disclosure, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, where M and N are integers greater than or equal to 1, and M is greater than N.

In the examples of the present disclosure, the plurality of zones includes a target zone and a non-target zone. The target zone is a zone where the memory mode is the first memory mode. The non-target zone may be a zone where the memory mode is the second memory mode. In addition, the information of the target zone may be stored in the target zone data structure, and the information of the non-target zone is not stored in the target zone data structure. In the examples of the present disclosure, the memory density of the memory space of the target zone is less than the memory density of the memory space of the non-target zone.

In an example of the present disclosure, N is equal to 1, and M is an integer greater than 1.

In the examples of the present disclosure, in the memory device, the memory cell may be divided into a single-level cell (SLC) and a multi-level cell (MLC) according to the difference in memory density. Correspondingly, the first memory mode may be a single-level cell (SLC) memory mode, and the second memory mode may be a multi-level cell (MLC) memory mode. The memory density of the first memory mode is less than the memory density of the second memory mode. The multi-level cell (MLC) memory mode may be at least one of a two-level cell memory mode, a triple-level cell (TLC) memory mode, and a quad-level cell (QLC) memory mode.

FIG. 1B is a second block diagram of a host provided in examples of the present disclosure. As shown in FIG. 1B, in the examples of the present disclosure, the host 110 is further configured with a file system 114. The file system 114 processes the input data such that the input data is stored at certain logical or physical locations in the memory system. For example, when the host 110 receives data through a user application (not shown), the host 110 may process the data using the file system 114 and then store the data in a memory system.

In some examples, the file system 114 may include a log file system (LFS), such as a Flash Friendly File System (F2FS) designed for a Linux kernel based on flash characteristics, or a journal flash file system (JFFS) as a Linux LFS related to a NOR flash device.

The F2FS may perform cold and hot separation on the write data of the user according to the access frequency of the write data of the user. For example, the F2FS may divide the write data of the user into hot data, warm data, and cold data according to the access frequency of the write data of the user. Both the warm data and the cold data are non-hot data.

In the examples of the present disclosure, the target zone data structure 113 may be created in the file system 114, and the target zone data structure 113 may be stored in the buffer 111.

In the examples of the present disclosure, the host processor 112 is configured to: determine, by the file system 114, a cold-hot attribute of the write data, and allocate the zone to the write data according to the cold-hot attribute of the write data; allocate a zone where the memory mode is the first memory mode to the write data when determining, by the file system 114, that the write data is hot data; and allocate a zone where the memory mode is the second memory mode to the write data when determining, by the file system 114, that the write data is non-hot data.

Here, the file system being F2FS is taken as an example for description. In the examples of the present disclosure, the F2FS may perform cold and hot separation on the written data, for example, determine a cold-hot attribute of the written data. Moreover, after determining the cold-hot attribute of the write data, the host processor may allocate a zone to the write data according to the cold-hot attribute of the write data. For example, the host processor allocates a zone where the memory mode is the first memory mode to the write data when determining that the write data is hot data through the F2FS. The host processor allocates a zone where the memory mode is the second memory mode to the write data when determining that the write data is non-hot data (e.g., warm data or cold data) by the F2FS.

In the examples of the present disclosure, a target zone data structure is created in F2FS to record information of a target zone in a plurality of zones. In some examples, the target zone is a zone where the memory mode is the SLC memory mode, and the “a zone where the memory mode is the SLC memory mode” is referred to as “SLC zone” for short, and the target zone data structure may store the information of the SLC zone. And, the SLC zone is to store hot data.

In the examples of the present disclosure, the target zone data structure includes a number of target zones, a list of target zone linked lists, and an identifier of a currently used target zone.

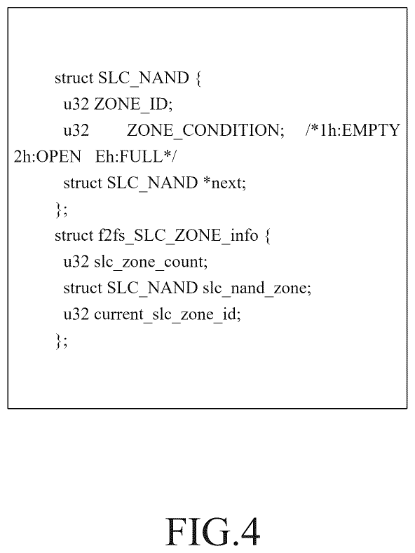

FIG. 4 is a target zone data structure according to an example of the present disclosure. FIG. 4 takes the target zone being an SLC zone as an example for description. As shown in FIG. 4, a target zone data structure named struct f2fs_SLC_ZONE_info is created in F2FS, where slc_zone_count represents the number of SLC zones in the memory device. Current_slc_zone_id represents the identifier of the SLC zone currently used by the hot data. Struct SLC_NAND slc_nand_zone represents the list of the SLC zone linked lists, and the information of the SLC zone is recorded in the list of the SLC zone linked lists.

In the examples of the present disclosure, the list of target zone linked lists includes at least one target zone linked list, and the target zone linked list includes an identifier of the target zone, the condition of the target zone, and a linked list pointer of a next target zone linked list.

As shown in FIG. 4, in the target zone linked list, ZONE_ID represents the identifier of the SLC zone, and ZONE_CONDITION represents the condition of the SLC zone. In an example, the condition of the SLC zone includes an empty condition (1h: EMPTY), an open condition (2h: OPEN), and a full condition (Eh: FULL). SLC _NAND*next represents a linked list pointer of the next SLC zone linked list.

In the examples of the present disclosure, a target zone data structure is newly added in the host and is configured to manage the information of the SLC zone in the memory system, so that the host processor can write the hot data into the SLC zone, thus the writing speed of the hot data is effectively improved.

In the examples of the present disclosure, the information of the target zone includes an identifier of the target zone, a condition of the target zone, and an identifier of the currently used target zone.

According to the foregoing description, it may be understood that the target data structure includes information of the target zone, and therefore, the target zone data structure may be maintained according to the information of the target zone.

In some examples, the host processor is configured to send a second command to indicate that the condition of the specified zone is reset to an empty condition.

In some examples, the second command is a command in ZBC. In an example, the second command is a reset write pointer command. Here, the second command is a command conforming to a Zoned Universal Flash Memory (zoned UFS) protocol format.

In some implementations, the reset write pointer command sent by the host may request the memory controller to perform a reset operation of the write pointer. The reset operation of the write pointer resets is an operation that resets the write pointer to an initial value. The initial value of the write pointer may be 0.

Here, the write pointer is to indicate the starting LBA of the write operation to start. The write pointer may be determined by the memory controller and may be allocated to each of the ZNS zones. For example, the memory controller may determine an initial value of the write pointer to indicate a starting point of a write for each zone. For example, when the initial value of the write pointer is 0 (for example, WP=0), the starting point of the write of the zone may be indicated as the starting LBA of the zone.

When writing the data to the zone, the write pointer is advanced or updated to point to or indicate the next LBA in the zone for writing data in order to track the next write starting point (e.g., the completion point of the previous write is equal to the starting point of the subsequent write). Thus, the write pointer may indicate where subsequent writes to the zone will begin.

Since the reset write pointer command may reset the write pointer to the initial value, e.g., point the write pointer to the starting LBA of the zone, the condition of the specified zone may be reset to the empty condition through the second command.

In the examples of the present disclosure, the host processor is configured to: send a second command, where the second command is to indicate to configure the at least one zone as the target zone.

In some examples, the second command may indicate to configure at least one zone in the empty condition as the target zone.

In some other examples, the second command may indicate to configure the specified zone in the empty condition as the target zone.

In the examples of the present disclosure, the second command may be a command in the ZBC for switching the condition of the zone. Here, after receiving the second command, the memory system may adjust the memory modes of the plurality of zones according to the second command.

In some examples, the memory controller may switch the memory mode of the at least one zone in the empty condition from the TLC memory mode to the SLC memory mode according to the received second command. Here, after receiving the second command, in some examples, the memory system may first reset the condition of the at least one zone to the empty condition, and then switch the memory mode of the at least one zone in the empty condition from the TLC memory mode to the SLC memory mode.

In some other examples, the memory controller may switch the memory mode of the specified zone in the empty condition from the TLC memory mode to the SLC memory mode according to the received second command. Here, after receiving the second command, in some examples, the memory system may first reset the condition of the specified zone to the empty condition, and then switch the memory mode of the specified zone in the empty condition from the TLC memory mode to the SLC memory mode.

In the examples of the present disclosure, the host processor is configured to: send the second command in a preset scenario, where the preset scenario includes at least one of the following: an initialization period of the file system, in a case where the information of the target zone is not obtained through the first command, and in a case where the condition of the currently used target zone in the target zone data structure is a full condition.

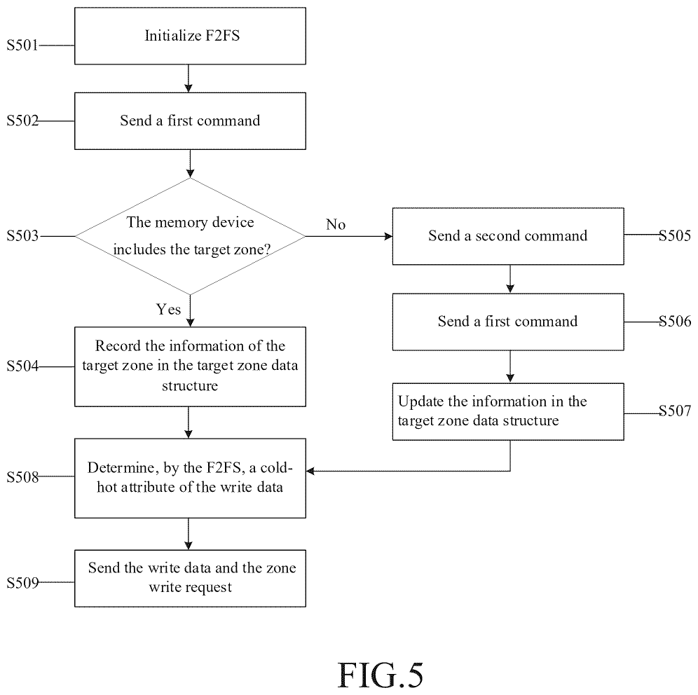

FIG. 5 is a flowchart of an operation method of a host provided in an example of the present disclosure. As shown in FIG. 5, in an example of the present disclosure, in operation S501, F2FS is initialized. At operation S502, the host processor may be configured to send a first command to the memory system. As such, the host processor may obtain the information of each zone in the memory device through the first command. In operation S503, whether the memory device includes the target zone is determined according to the report zone parameter data including the memory mode information, for example, the target zone is an SLC zone. If there is an SLC zone in the memory device, the method proceeds to operation S504, where the host processor records the information of the target zone (SLC zone) in the target zone data structure. If there is no SLC zone in the memory device, the method proceeds to operation S505, where the host processor is configured to send a second command to the memory system to instruct the memory controller to configure the at least one zone in the memory device as the SLC zone through the second command. Here, since the memory controller may be instructed to switch the memory mode of the specified zone to the target memory mode through the second command, the mode switching information generated by the host may indicate that the target memory mode is the first memory mode, and the memory controller may be instructed to switch the memory mode of the specified zone to the first memory mode through the second command carrying the identifier of the specified zone and the mode switching information, so that the configuration of the target zone may be achieved through the second command. Next, in operation S506, the host processor again sends the first command to the memory system to obtain the report zone parameter data including the memory mode information again. Since the SLC zone has been configured through the second command before operation S506, the report zone parameter data obtained by operation S506 has the information of the SLC zone, and based on this, in operation S507, the information in the target zone data structure is updated according to the latest obtained information of the SLC zone. For example, the information of the SLC zone configured by operation S505 is updated into the target zone data structure.

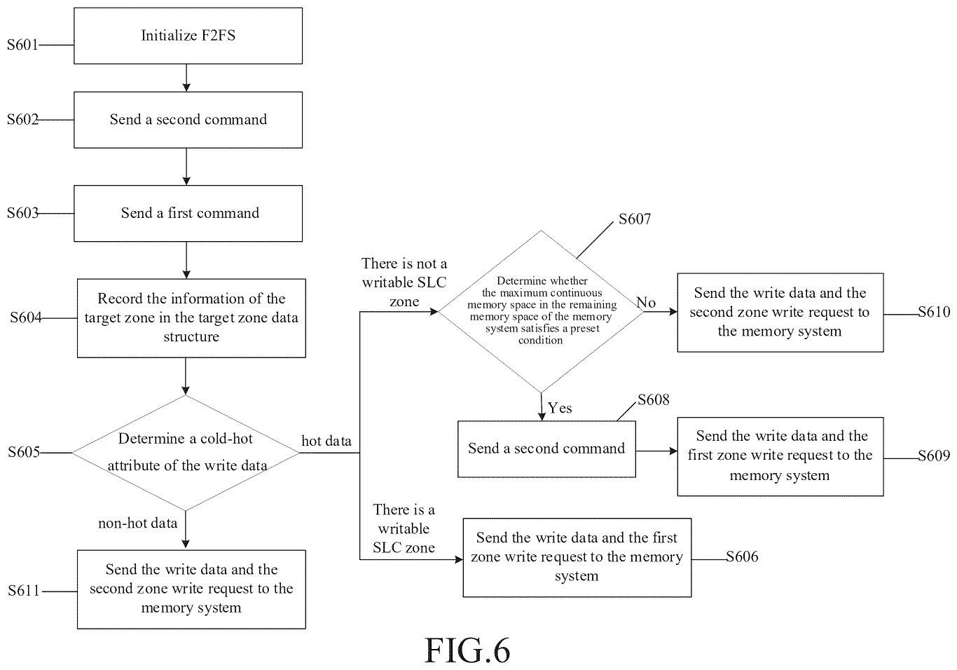

FIG. 6 is a flowchart of another operation method of a host according to an example of the present disclosure. As shown in FIG. 6, in another example of the present disclosure, in operation S601, F2FS is initialized. At operation S602, the host processor may send a second command to the memory system to instruct the memory controller to configure at least one zone in the memory device as an SLC zone, thus ensuring that there is at least one SLC zone in the memory device. In an example, the second command may be employed to instruct the memory controller to configure a first one-third of the plurality of zones of the memory device as an SLC zone. Next, in operation S603, the host processor sends a first command to the memory system to obtain the information of the SLC zone in the memory device. And in operation S604, the information of the SLC zone is updated into the target zone data structure.

In yet another example of the present disclosure, when the condition of the currently used SLC zone in the target zone data structure is the full condition, the host processor may send the second command to the memory system to instruct the memory controller to configure the at least one zone in the memory device as the SLC zone. Subsequently, the host processor sends a first command to the memory system and obtain information of all zones in the memory device. The data in the target zone data structure is updated according to the obtained information of all the zones.

In the examples of the present disclosure, after the host processor sends the second command to the memory system each time, the host processor further needs to send the first command to the memory system to update the data in the target zone data structure.

In the examples of the present disclosure, the host processor is configured to: determine, by the file system, a cold-hot attribute of the write data, generate a corresponding zone write request according to the cold-hot attribute of the write data, and send the write data and the zone write request; the zone write request is to indicate to write the write data into a zone where the memory mode is the first memory mode when determining that the write data is hot data by the file system, and the zone write request is to indicate to write the write data into a zone where the memory mode is the second memory mode when determining that the write data is non-hot data by the file system.

As shown in FIG. 5, in operation S508, when the host prepares to write data to the memory device, the host processor may determine a cold-hot attribute of the write data through the F2FS. Thereafter, the host processor generates a corresponding zone write request according to the cold-hot attribute of the write data, and in operation S509, sends the write data and the zone write request to the memory system. In this case, if the write data is determined to be hot data, the zone write request indicates that the write data is written into the SLC zone. If the write data is determined to be non-hot data, the zone write request indicates that the write data is written into the non-target zone. For example, the non-target zone is a TLC zone.

In an example, when the host processor determines that the write data is hot data through the F2FS, the host processor may send the write data and the zone write request to the memory system according to the current_slc_zone_id in the target zone data structure, to indicate that the write data is written into the SLC zone corresponding to the identifier. For example, if the host processor determines that the write data is hot data by the F2FS, the host processor sends the hot data and the zone write request to the memory system, where the zone write request includes an identifier of an SLC zone currently used by the hot data that is in a non-full condition (for example, an empty condition or an open condition). For example, if the host processor determines that the write data is hot data for the first time, the zone write request includes the identifier of the first SLC zone in the non-full condition pointed to after the F2FS initialization.

In the examples of the present disclosure, after the current hot data is written into the memory device, if the SLC zone currently used by the hot data is in a full condition, the current_slc_zone_id in the target zone data structure would point to the next SLC zone in the non-full condition, so as to write the next hot data. In some examples, if there is no SLC zone in the memory device that can be employed to write the hot data in the non-full condition, the host processor needs to send the second command to the memory system to configure the at least one zone in the non-full condition as the SLC zone.

When the host processor determines that the write data is non-hot data through the F2FS, the host processor may sequentially select a zone in a non-full condition, and traverse the SLC zone linked list in the target zone data structure to determine whether the currently selected zone is the SLC zone. If it is determined that the zone is the SLC zone, the zone is skipped, and the next zone is selected until a TLC zone is found, for example, a zone where the memory mode is the second memory mode. Thereafter, in operation S509, write data and a zone write request are sent to indicate to write the write data to the TLC zone.

In the examples of the present disclosure, the memory mode information of each zone in the zone namespace (ZNS) can be obtained by the report zone command, so that the memory mode of each zone can be obtained. As such, when data writing is performed, the zone where the memory mode is the first memory mode is allocated to the hot data and the zone where the memory mode is the second memory mode is allocated to the non-hot data selectively based on the cold-hot attribute of the write data. The write data may be divided into hot data and non-hot data according to the access frequency, where the non-hot data may refer to data whose access frequency is lower than the memory setting reference value, and the predetermined memory duration is relatively long; the hot data may refer to data whose access frequency is higher than the memory setting reference value, and the predetermined memory duration is relatively low. The non-hot data includes cold data and warm data, the access frequency of the warm data is larger than that of the cold data, but lower than that of the hot data. Therefore, the zone where the memory mode is the first memory mode may be employed to store the hot data with a shorter predetermined memory duration, and the zone where the memory mode is the second memory mode may be employed to store the non-hot data with a longer predetermined memory duration. As such, the service life of the memory device can be prolonged by allocating corresponding memory mode to the zone based on the cold-hot attributes of the write data.

In the examples of the present disclosure, the host processor is configured to: determine to obtain a remaining space of the memory system when the condition of the currently used target zone in the target zone data structure is a full condition; and send the second command to the memory system according to a maximum continuous space in the remaining space satisfying a preset condition.

In the examples of the present disclosure, during normal operation of the file system, the file system may recycle the used zone through a garbage collection (GC), so that the zone may be reused for writing data. However, when a large amount of hot data is frequently written in the memory device, there may not be enough memory space in the memory device that can be recycled by the GC and can be configured as a target zone. In this case, the host processor needs to obtain the remaining space of the memory system, and determine whether to send the second command to the memory system according to whether the maximum continuous space in the remaining space satisfies the preset condition.

As shown in FIG. 6, in operation S605, a cold-hot attribute of the write data is determined. When the write data is hot data, it is determined whether there is a writable SLC zone in the zone data structure, and in a case where there is a writable SLC zone in the zone data structure, the method proceeds to operation S606, for example, the write data and the first zone write request are sent to the memory system to instruct the memory system to write the hot data into the SLC zone. Here, the first zone write request is employed to instruct to write the write data into the SLC zone.

In a case where there is no writable SLC zone in the zone data structure, for example, when the condition of the currently used SLC zone is a full condition, the method proceeds to operation S607. In operation S607, it is determined whether the maximum continuous memory space in the remaining memory space of the memory system satisfies a preset condition. For example, the preset condition may be that the maximum continuous memory space in the remaining memory space of the memory system is greater than or equal to the memory space occupied by the two non-target zones, for example, the non-target zone is a TLC zone. If the maximum continuous memory space in the remaining memory space of the memory system satisfies the preset condition, the method proceeds to operation S608, and the host processor sends a second command to the memory system to configure the memory space corresponding to the at least one zone of the maximum continuous memory space in the remaining memory space as the SLC zone. For example, the half zone of the maximum continuous memory space in the remaining memory space may be configured as an SLC zone. Thereafter, the host processor may send a first command to the memory system to update and maintain the target zone data structure. Also, in operation S609, the write data and the first zone write request are sent to the memory system to instruct the memory system to write the hot data into the SLC zone. If the maximum continuous memory space in the remaining memory space of the memory system does not satisfy the preset condition, the configuration of the SLC zone cannot be performed because the preset condition is not satisfied, so that the host cannot allocate the writable SLC zone for the hot data, thereby the method proceeds to operation S610, the write data and the second zone write request are sent to the memory system to instruct the memory system to write the hot data into the TLC zone.

As shown in FIG. 6, if it is determined that the write data is non-hot data in operation S605, the method proceeds to operation S611. In operation S611, write data and a second zone write request are sent to the memory system to instruct the memory system to write non-hot data into the TLC zone.

The examples of the present disclosure further provide a system, including a host and a memory system coupled to the host; the memory system includes a memory device and a memory controller coupled to the memory device, the memory controller is configured to control the memory device to partition and store by zones, where a memory space of a single zone is configured to support only sequential writes; the host includes a host processor, a buffer, and a second interface for coupling to the memory controller, where the buffer is configured to store a target zone data structure, and the host processor is configured to: send a first command to the memory controller through the second interface; the first command is to obtain information of each zone of a ZNS; the memory controller is configured with a first interface for coupling to the host, and the memory controller is configured to: receive the first command through the first interface; send report zone parameter data to the host through the first interface according to the first command; the report zone parameter data includes memory mode information indicating a memory mode of the zone; and the host processor is further configured to: maintain the target zone data structure based on the information of each zone, where the target zone data structure includes information of a target zone, and the target zone is a zone where the memory mode is a first memory mode.

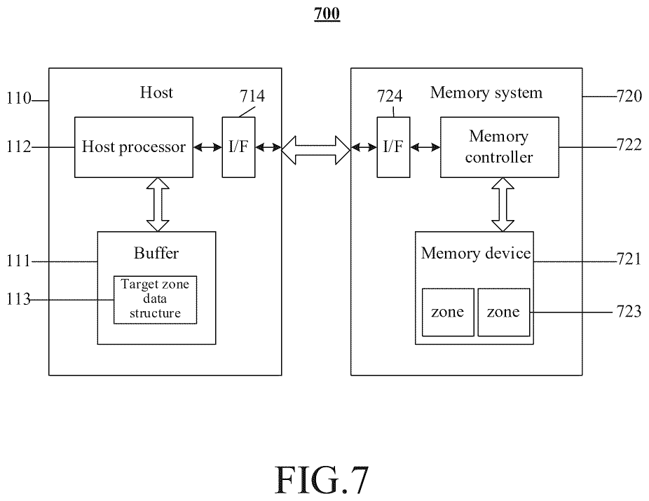

FIG. 7 is a block diagram of an example system with a host and a memory system according to some aspects of the present disclosure.

In the examples of the present disclosure, the system may be a mobile phone, a desktop computer, a laptop computer, a tablet computer, a vehicle computer, a game console, a printer, a pointing device, a wearable electronic device, a smart sensor, a virtual reality (VR) device, an augmented reality (AR) device, or any other suitable electronic device having a memory device therein.

As shown in FIG. 7, the system includes a host 110 and a memory system 720 coupled to the host 110. The memory system 720 has one or more memory devices 721, a memory controller 722 coupled to the memory device 721, and an interface (I/F) 724 (e.g., a first interface) with the host. The memory controller 722 may manage data stored in the memory device 721 and communicate with the host 110. The memory device 721 includes a plurality of zones 723, and the memory controller 722 may control the memory device 721 to partition and store by zones. The host 110 includes a host processor 112, a buffer 111, and an interface (I/F) 714 (e.g., a second interface) with the memory controller 722, where the buffer 111 is configured to store the target zone data structure 113. In particular, the host 110 may send a first command to the memory controller 722 through the interface 714, and the memory controller 722 may receive the first command through the interface 724. The host 110 may be a processor (e.g., a central processing unit (CPU)) or a system-on-a-chip (SoC) (e.g., an application processor (AP)) of an electronic device. The host 110 may be configured to send or receive data to or from the memory device 721. Here, the example structure and composition of the host 110 may refer to the related structure and composition of the host in FIG. 1A and FIG. 1B, and details are not described herein again for brevity.

In some implementations, the memory controller 722 is designed to operate in a low duty cycle environment, such as a secure digital (SD) card, a compact flash memory (CF) card, a universal serial bus (USB) flash drive, or other medium for use in electronic devices such as personal computers, digital cameras, mobile phones, and the like. In some implementations, the memory controller 722 is designed to operate in a high duty cycle environment SSD or embedded multimedia card (eMMC), which serves as a data store for mobile devices such as smartphones, tablets, laptops, and the like, as well as enterprise memory arrays.

The memory controller 722 may be configured to control operations of the memory device 721, such as read, erase, and program operations. The memory controller 722 may also be configured to manage various functions regarding data stored in or to be stored in the memory device 721, including, but not limited to, bad block management, garbage collection, logical-to-physical address translation, wear leveling, and the like. In some implementations, the memory controller 722 is further configured to process error correction codes (ECC) regarding data read from or written to the memory device 721. The memory controller 722 may also perform any other suitable functions, such as formatting memory device 721. The memory controller 722 may communicate with an external device (e.g., host 110) according to a particular communication protocol. For example, the memory controller 722 may communicate with external devices through at least one of a variety of interface protocols, such as a USB protocol, an MMC protocol, a Peripheral Component Interconnect (PCI) protocol, a PCI Express (PCI-E) protocol, an Advanced Technology Attachment (ATA) protocol, a Serial ATA protocol, a parallel ATA protocol, a Small Computer Small Interface (SCSI) protocol, an Enhanced Small Disk Interface (ESDI) protocol, an Integrated Drive Electronics (IDE) protocol, a Firewire protocol, or the like. These interfaces 724 may also be referred to as first interfaces (also referred to as frontend interfaces). In some examples, the memory controller 722 performs command/data interaction with the memory device 721 through a plurality of configured channels. These channels are also referred to as third interfaces (also referred to as backend interfaces).

The memory controller 722 and the one or more memory devices 721 may be integrated into various types of memory devices, e.g., included in the same package (e.g., a Universal Flash Memory (UFS) package or an eMMC package). For example, the memory system 720 may be implemented and packaged into different types of end electronics. In one example, the memory controller 722 and the single memory device 721 may be integrated into a memory card. The memory card may include PC card (PCMCIA, Personal Computer Memory Card International Association), CF card, smart media (SM) card, memory stick, multimedia card (MMC, RS-MMC, MMCmicro), SD card (SD, miniSD, microSD, SDHC), UFS, and the like. The memory card may also include a memory card connector coupling the memory card to the host 110. In another example, the memory controller 722 and the plurality of memory devices 721 may be integrated into the SSD. The SSD may also include an SSD connector coupling the SSD to the host 110. In some implementations, the memory capacity and/or operating speed of the SSD is greater than the memory capacity and/or the operating speed of the memory card.

In the examples of the present disclosure, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, where M and N are integers greater than or equal to 1, and M is greater than N.

In the examples of the present disclosure, N is equal to 1, and M is an integer greater than 1.

In the examples of the present disclosure, the host processor 112 is configured to: send a second command to the memory controller through the second interface; and the memory controller 722 is configured to: receive a second command through the first interface; and configure at least one of the plurality of zones as the target zone according to the second command.

In the examples of the present disclosure, the information of the target zone includes an identifier of the target zone, a condition of the target zone, and an identifier of the currently used target zone.

In the examples of the present disclosure, the target zone data structure 113 includes a number of target zones, a list of target zone linked lists, and the identifier of the currently used target zone, where the list of target zone linked lists includes at least one target zone linked list, and the target zone linked list includes an identifier of the target zone, the condition of the target zone, and a linked list pointer of a next target zone linked list.

In the examples of the present disclosure, the host 110 is further configured with a file system (not shown in FIG. 7), and the host processor 112 is configured to: send a second command to the memory system 720 in a preset scenario, where the preset scenario includes at least one of the following: an initialization period of the file system, in a case where the information of the target zone is not obtained through the first command, and in a case where the condition of the currently used target zone in the target zone data structure 113 is a full condition.

In the examples of the present disclosure, the host processor 112 is configured to: determine, by the file system, a cold-hot attribute of the write data, and allocate the zone to the write data according to the cold-hot attribute of the write data; allocate a zone where the memory mode is the first memory mode to the write data when determining, by the file system, that the write data is hot data; and allocate a zone where the memory mode is the second memory mode to the write data when determining, by the file system, that the write data is non-hot data.

In the examples of the present disclosure, the host processor 112 is configured to: determine, by the file system, a cold-hot attribute of the write data, generate a corresponding zone write request according to the cold-hot attribute of the write data, and send the write data and the zone write request to the memory controller 722 through the second interface; the zone write request is to indicate to write the write data into a zone where the memory mode is the first memory mode when determining, by the file system, that the write data is hot data, and the zone write request is to indicate to write the write data into a zone where the memory mode is the second memory mode when determining, by the file system, that the write data is non-hot data; and the memory system 720 is configured to: receive the write data and the zone write request through the first interface; and write the write data into the memory space of the corresponding zone according to the zone write request.

In the examples of the present disclosure, the host processor 112 is configured to: determine to obtain a remaining space of the memory device 721 when the condition of the currently used target zone in the target zone data structure is a full condition; and send the second command to the memory system through the second interface according to a maximum continuous space in the remaining space satisfying a preset condition; and the memory system 720 is configured to: receive the second command through the first interface; and configure at least one of the plurality of zones as the target zone according to the second command.

In the examples of the present disclosure, the first command includes a report zone command, and the second command includes a reset write pointer command.

In the examples of the present disclosure, the file system includes a flash friendly file system.

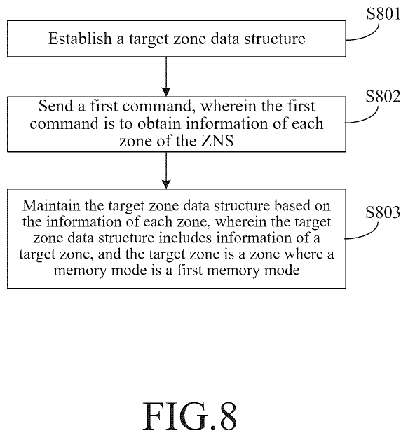

FIG. 8 is a flowchart of an operation method of a host according to an example of the present disclosure. As shown in FIG. 8, the examples of the present disclosure further provide an operation method of a host, including:
Operation S801: Establishing a target zone data structure;
Operation S802: Sending a first command, where the first command is to obtain information of each zone of the ZNS.
Operation S803: Maintaining the target zone data structure based on the information of each zone, where the target zone data structure includes information of a target zone, and the target zone is a zone where a memory mode is a first memory mode.

In the examples of the present disclosure, the operation method of the host further includes: obtaining report zone parameter data through the first command, where the report zone parameter data includes memory mode information indicating a memory mode of the zone; and obtaining the information of the target zone according to the report zone parameter data.

In the examples of the present disclosure, the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, where M and N are integers greater than or equal to 1, and M is greater than N.

In the examples of the present disclosure, N is equal to 1, and M is an integer greater than 1.

In the examples of the present disclosure, the operation method of the host further includes: sending a second command, where the second command is to instruct to configure at least one zone as the target zone.

In the examples of the present disclosure, the information of the target zone includes an identifier of the target zone, a condition of the target zone, and an identifier of the currently used target zone.

In the examples of the present disclosure, the target zone data structure includes a number of target zones, a list of target zone linked lists, and the identifier of the currently used target zone, where the list of target zone linked lists includes at least one target zone linked list, and the target zone linked list includes an identifier of the target zone, the condition of the target zone, and a linked list pointer of a next target zone linked list.

In the examples of the present disclosure, the establishing the target zone data structure includes: establishing the target zone data structure through a configured file system; the sending the second command includes: sending the second command in a preset scenario, where the preset scenario includes at least one of the following: an initialization period of the file system, in a case where the information of the target zone is not obtained through the first command, and in a case where the condition of the currently used target zone in the target zone data structure is a full condition.

In the examples of the present disclosure, the operation method of the host further includes: determining, by the file system, a cold-hot attribute of the write data, and allocate the zone to the write data according to the cold-hot attribute of the write data; allocating a zone where the memory mode is the first memory mode to the write data when determining, by the file system, that the write data is hot data; and allocating a zone where the memory mode is the second memory mode to the write data when determining that the write data is non-hot data.

In the examples of the present disclosure, the operation method of the host further includes: determining, by the file system, a cold-hot attribute of the write data, generating a corresponding zone write request according to the cold-hot attribute of the write data, and sending the write data and the zone write request; the zone write request is to indicate to write the write data into a zone where the memory mode is the first memory mode when determining, by the file system, that the write data is hot data, and the zone write request is to indicate to write the write data into a zone where the memory mode is the second memory mode when determining, by the file system, that the write data is non-hot data.

In the examples of the present disclosure, the sending the second command when the condition of the currently used target zone in the target zone data structure is a full condition includes: determining to obtain a remaining space of a target device when the condition of the currently used target zone in the target zone data structure is a full condition; and sending the second command according to a maximum continuous space in the remaining space satisfying a preset condition.

In the examples of the present disclosure, the first command includes a report zone command, and the second command includes a reset write pointer command.

In the examples of the present disclosure, the file system includes a flash friendly file system.

The examples of the present disclosure further provide a computer-readable memory medium comprising computer programs that are executed to perform the method of any one of the foregoing examples.

In the examples of the present disclosure, the computer-readable memory medium may be a ferromagnetic random access memory (FRAM), a read-only memory (ROM), a programmable read-only memory (PROM), an erasable programmable read-only memory (EPROM, Erasable Programmable Read-Only Memory), an electrically erasable programmable read-only memory (EEPROM), a flash memory, a magnetic surface memory, an optical disk, or a compact disc read-only memory (CD-ROM), and the like; or may be various devices including one or any combination of the foregoing memories.

In some examples, the computer program may be written in the form of a program, software, software module, script, or code, written in any form of programming language (including compiled or interpreted languages, or declarative or procedural languages), and it may be deployed in any form, including being deployed as a standalone program or as a module, component, subroutine, or other unit suitable for use in a computing environment.

As an example, a computer program may, but is not necessarily, correspond to a file in a file system, may be stored in a portion of a file that saves other programs or data, for example, in one or more scripts stored in a hypertext markup language (HTML) document, in a single file dedicated to the program in question, or in a plurality of collaborative files (e.g., files that store one or more modules, subroutines, or portions of code).

As an example, a computer program may be deployed for execution on one computing device, or on multiple computing devices located at one location, or alternatively on multiple computing devices distributed at multiple locations and interconnected over a communications network.

The examples of the present disclosure provide a host and an operation method thereof, system and a computer readable memory medium. The host includes: a buffer configured to store a target zone data structure; and a host processor configured to: send a first command, where the first command is to obtain information of each zone of a zone namespace (ZNS); and maintain the target zone data structure based on the information of each zone, where the target zone data structure includes information of a target zone, and the target zone is a zone where a memory mode is a first memory mode. In the examples of the present disclosure, the target zone data structure is stored in the buffer of the host, and the target zone data structure may be configured to manage information of a target zone where the memory mode is the first memory mode. Meanwhile, the host processor may send a first command, where the first command is used to obtain information of each zone of the ZNS, and maintain the target zone data structure based on the information of each zone.

“One example” or “an example” mentioned throughout the specification means that certain features, structures, or characteristics related to the examples are included in at least one example of the present disclosure. Thus, “in one example” or “in an example” appearing throughout the specification need not necessarily refer to the same example. Further, these particular features, structures, or characteristics may be incorporated in one or more examples in any suitable manner. In various examples of the present disclosure, the sequence numbers of the foregoing processes do not mean the order of execution, and the execution sequence of each process should be determined by using its function and internal logic, and should not constitute any limitation on the implementation process of the examples of the present disclosure. The foregoing sequence numbers of the examples of the present disclosure are merely for description, and do not represent the advantages of the examples.

The above description is only preferred implementations of the present disclosure, and is not intended to limit the scope of the disclosure of the present disclosure, and any equivalent structural transformation or direct/indirect application made by using the present disclosure and the accompanying drawings is included within the scope of the present disclosure.

What is claimed is:

1. A host, comprising:
a buffer configured to store a target zone data structure; and
a host processor configured to:
send a first command, wherein the first command is to obtain information of each zone of a zone namespace (ZNS); and
maintain the target zone data structure based on the information of each zone, wherein the target zone data structure includes information of a target zone, and the target zone is a zone where a memory mode is a first memory mode.

2. The host of claim 1, wherein the host processor is configured to:
obtain report zone parameter data through the first command, wherein the report zone parameter data includes memory mode information indicating a memory mode of the zone; and
obtain the information of the target zone according to the report zone parameter data.

3. The host of claim 1, wherein the memory mode includes a first memory mode and a second memory mode; when the zone is in the first memory mode, N bits of data can be written into each of memory cells corresponding to a memory space of the zone; and when the zone is in the second memory mode, M bits of data can be written into each of memory cells corresponding to the memory space of the zone, wherein M and N are integers greater than or equal to 1, and M is greater than N.

4. The host of claim 1, wherein the host processor is configured to:
send a second command, wherein the second command is to instruct to configure at least one zone as the target zone.

5. The host of claim 1, wherein the information of the target zone includes an identifier of the target zone, a condition of the target zone, and an identifier of a currently used target zone.

6. The host of claim 5, wherein the target zone data structure includes a number of target zones, a list of target zone linked lists, and the identifier of the currently used target zone, wherein the list of target zone linked lists includes at least one target zone linked list, and the target zone linked list includes an identifier of the target zone, the condition of the target zone, and a linked list pointer of a next target zone linked list.

7. The host of claim 4, wherein the host is further configured with a file system, and the host processor is configured to:
send the second command in a preset scenario, wherein the preset scenario includes at least one of the following: an initialization period of the file system, in a case where the information of the target zone is not obtained through the first command, and in a case where a condition of a currently used target zone in the target zone data structure is a full condition.

8. The host of claim 7, wherein the host processor is configured to:
determine, by the file system, a cold-hot attribute of write data, and allocate a zone to the write data according to the cold-hot attribute of the write data; allocate a zone where the memory mode is the first memory mode to the write data when determining, by the file system, that the write data is hot data; and allocate a zone where the memory mode is a second memory mode to the write data when determining, by the file system, that the write data is non-hot data.

9. The host of claim 7, wherein the host processor is configured to:
determine, by the file system, a cold-hot attribute of write data, generate a zone write request according to the cold-hot attribute of the write data, and send the write data and the zone write request, wherein the zone write request is to indicate to write the write data into a zone where the memory mode is the first memory mode when determining, by the file system, that the write data is hot data, and the zone write request is to indicate to write the write data into a zone where the memory mode is a second memory mode when determining, by the file system, that the write data is non-hot data.

10. The host of claim 7, wherein the host processor is configured to:
determine to obtain a remaining space of a memory system coupled to the host when the condition of the currently used target zone in the target zone data structure is a full condition; and
send the second command to the memory system according to a maximum continuous space in the remaining space satisfying a preset condition.

11. A system, comprising: a host and a memory system coupled to the host, wherein the memory system includes a memory device and a memory controller coupled to the memory device, the memory controller is configured to control the memory device to partition and store by zones, and a memory space of a single zone is configured to support only sequential writes;
the host includes a host processor, a buffer, and a second interface for coupling to the memory controller, wherein the buffer is configured to store a target zone data structure, and the host processor is configured to: send a first command to the memory controller through the second interface, wherein the first command is to obtain information of each zone of a ZNS;
the memory controller is configured with a first interface for coupling to the host, and the memory controller is configured to: receive the first command through the first interface; and send report zone parameter data to the host through the first interface according to the first command, wherein the report zone parameter data includes memory mode information indicating a memory mode of the zone; and
the host processor is further configured to: maintain the target zone data structure based on the information of each zone, wherein the target zone data structure includes information of a target zone, and the target zone is a zone where the memory mode is a first memory mode.

12. The system of claim 11, wherein the memory mode includes a first memory mode and a second memory mode; when the zone is in the first memory mode, N bits of data can be written into each of memory cells corresponding to the memory space of the zone; and when the zone is in the second memory mode, M bits of data can be written into each of memory cells corresponding to the memory space of the zone, wherein M and N are integers greater than or equal to 1, and M is greater than N.

13. The system of claim 11, wherein the host processor is configured to:
send a second command to the memory controller through the second interface; and
the memory controller is configured to: receive the second command through the first interface; and configure at least one of a plurality of zones as the target zone according to the second command.

14. The system of claim 11, wherein the information of the target zone includes an identifier of the target zone, a condition of the target zone, and an identifier of a currently used target zone.

15. The system of claim 13, wherein the host is further configured with a file system, and the host processor is configured to:
send the second command to the memory system in a preset scenario, wherein the preset scenario includes at least one of the following: an initialization period of the file system, in a case where the information of the target zone is not obtained through the first command, and in a case where a condition of a currently used target zone in the target zone data structure is a full condition.

16. An operation method of a host, comprising:
establishing a target zone data structure;
sending a first command, wherein the first command is to obtain information of each zone of a zone namespace (ZNS); and
maintaining the target zone data structure based on the information of each zone, wherein the target zone data structure includes information of a target zone, and the target zone is a zone where a memory mode is a first memory mode.

17. The method of claim 16, further comprising:
obtaining report zone parameter data through the first command, wherein the report zone parameter data includes memory mode information indicating a memory mode of the zone; and
obtaining the information of the target zone according to the report zone parameter data.

18. The method of claim 16, further comprising:
sending a second command, wherein the second command is to instruct to configure at least one zone as the target zone.

19. The method of claim 18, wherein the establishing the target zone data structure includes:
establishing the target zone data structure by a file system; and
the sending the second command includes:
sending the second command in a preset scenario, wherein the preset scenario includes at least one of the following: an initialization period of the file system, in a case where the information of the target zone is not obtained through the first command, and in a case where a condition of a currently used target zone in the target zone data structure is a full condition.

20. The method of claim 19, further comprising:
determining, by the file system, a cold-hot attribute of write data, and allocating the zone to the write data according to the cold-hot attribute of the write data; allocating a zone where the memory mode is the first memory mode to the write data when determining, by the file system, that the write data is hot data; and allocating a zone where the memory mode is a second memory mode to the write data when determining that the write data is non-hot data; or
determining, by the file system, a cold-hot attribute of write data, generating a zone write request according to the cold-hot attribute of the write data, and sending the write data and the zone write request, wherein the zone write request is to indicate to write the write data into a zone where the memory mode is the first memory mode when determining, by the file system, that the write data is hot data, and the zone write request is to indicate to write the write data into a zone where the memory mode is a second memory mode when determining, by the file system, that the write data is non-hot data.
